(19) United States
(12) Patent Application Publication
(10) Pub. No.: US 2009/0283115 A1
(43) Pub. Date: Nov. 19, 2009

(54) Gun bore cleaner

(76) Inventor: David J. Dentico, Walworth, NY (US)

Correspondence Address: HOWARD J. GREENWALD P.C., 70 LINDEN OAKS, THIRD FLOOR, ROCHESTER, NY, 14625, US

(21) Appl. No.: 12/387,687

(22) Filed: May 6, 2009

Related U.S. Application Data
(60) Provisional application No. 61/127,587, filed on May 14, 2008.

(51) Int. Cl. B08B 9/043

(52) U.S. Cl. 134/22.1; 15/104.05

(57) ABSTRACT

An assembly for cleaning a bore that contains a body and a cleaning material located over the body. At least one resilient cleaning material is located between the body and the cleaning material. When the assembly is inserted into a bore, the resilient material extends outwardly towards to the bore, thus insuring contact of the cleaning material with the bore.

### CROSS-REFERENCE TO RELATED PATENT APPLICATION

This application claims priority based upon provisional patent application 61/127,587, filed on May 14, 2009.

### FIELD OF THE INVENTION

A gun bore cleaner comprised of a body, a material removably connected to the periphery of the body, and means for attaching the body to a cleaning rod.

### BACKGROUND OF THE INVENTION

Devices for cleaning the bores of guns are well known. However, none of these prior art devices is adapted to efficiently clean the entire interior diameter of the bores of most guns. The bores of such guns have a nominal interior diameter; and none of the prior art cleaning devices contact the entire surface of the such interior diameter. It is an object of this invention to provide a bore cleaner that, when used in conjunction with a cleaning patch, effectively cleans the entire surface of the interior bore diameter of guns.

### SUMMARY OF THE INVENTION

In accordance with this invention, there is provided a gun bore cleaner comprised of a body, a material continuously disposed about the periphery of such body, and means for attaching the body to a cleaning rod.

### BRIEF DESCRIPTION OF THE DRAWINGS

The invention will be described by reference to the specification, the claims, and the attached drawings in which like numerals refer to like elements, and wherein:

FIG. 1 is a perspective view of the front of one preferred bore cleaner;

FIG. 2 is a perspective view of the back of the bore cleaner of FIG. 1;

FIGS., 3, 4, and 5 are side views of the bore cleaner of FIG. 1;

FIG. 6 is an end view of the bore cleaner of FIG. 1;

FIG. 7 is a front view of an O-ring used in the bore cleaner of FIG. 1;

FIG. 8 is a side view of the O-ring of FIG. 7;

FIG. 9 is a perspective view of another bore cleaner;

FIG. 10 is a side view of the bore cleaner of FIG. 9;

FIG. 11 is a side view of a portion of the bore cleaner of FIG. 9;

FIG. 12 is a schematic view of the bore cleaner of FIG. 9; and

FIG. 13 is an end view of the bore cleaner of FIG. 9;

FIG. 14 presents both a side and end view of an O-ring used in the bore cleaner of FIG. 9;

FIG. 15 is an exploded view of a cleaning assembly that utilizes the bore cleaner of FIG. 1;

FIG. 16 is a perspective view of a cleaning assembly that utilizes the bore cleaner of FIG. 1;

FIG. 17 is a side view of an assembly that uses the bore cleaner of FIG. 9;

FIG. 18 is an exploded view illustrating a process utilizing the bore cleaner of FIG. 1;

FIG. 19 is an assembled view of the process of FIG. 18;

FIG. 20 illustrates a portion of the process of FIG. 19;

FIGS. 21, 22, 23, and 24 illustrate a cleaning process utilizing the bore cleaner of FIG. 9;

FIGS. 25, 26, and 27 illustrate a cleaning process utilizing the bore cleaner of FIG. 1; and

FIGS. 28 and 29 are schematic views illustrating another embodiment of the bore cleaner of the invention.

### DESCRIPTION OF THE PREFERRED EMBODIMENTS

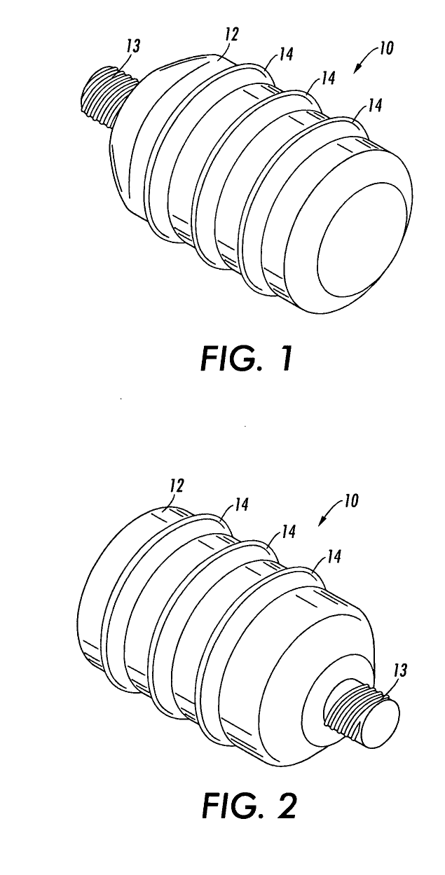

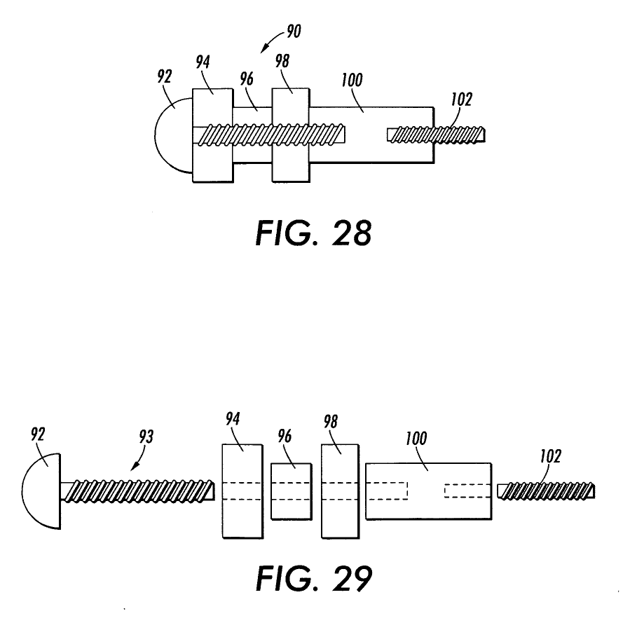

FIG. 1 is a perspective view of one embodiment of a gun bore cleaner 10, showing a front view thereof. Referring to FIG. 1, it will be seen that gun bore cleaner 10 is comprised of a body 12 that, in the embodiment depicted, in an integral assembly. By comparison, the body used in the embodiments depicted in FIGS. 28 and 29 is not integral.

In one preferred embodiment, the body 12 is comprised of or consists essentially of aluminum alloy such as, e.g., 6061 aluminum alloy. This aluminum alloy, in one embodiment, contains at least 0.4 weight percent of silicon, at least 0.15 weight percent of copper, at least 0.8 weight percent of magnesium, at least 0.04 weight percent of chromium, with the major amount of the alloy being comprised of aluminum.

In another preferred embodiment, the body 12 is comprised of or consists essentially of steel such as, e.g., carbon steel. One preferred carbon steel is 12L14 steel that is comprised of from about 0.85 to about 1.15 weight percent of manganese, from about 0.04 to about 0.09 weight percent of phosphorous, from about 0.26 to about 0.35 weight percent of sulfur, and from about 0.15 to about 0.35 weight percent of lead, with a major amount of such material being iron. As is known to those skilled in the art, this carbon steel is readily machined.

In another preferred embodiment, the body 12 is comprised of or consists essentially of brass such as, e.g., half-hard brass; one preferred half-hard brass is 650 half-hard brass. Half-hard brass typically has a density of about 8.5 grams per cubic centimeter and is comprised of about 70 weight percent of copper and about 30 weight percent of zinc.

Alternatively, or additionally, the body 12 may be comprised of or consist essentially of plastic material (such as, e.g., DELRIN, plastics suitable for injection molding, plastics suitable for machining, plastics suitable for compression molding, etc.), other metal alloy materials (such as, e.g., titanium-containing alloys, stainless steel, copper alloys, zinc alloys, and the like).

In one embodiment, the body 12 is comprised of or consists essentially of elastomeric material, such as rubber or synthetic rubber. In one aspect of this embodiment, the 0-rings 14 (see, e.g., FIG. 5) are integrally connected to said body.

Alternatively, the body 12 may be made from compressed metal compositions.

Referring again to FIG. 1, and in the preferred embodiment depicted, it will be seen that a multiplicity of O-rings 14 is connected to body 12. These O-rings are integral assemblies that extend continuously around the periphery of body 12. Without wishing to be bound to any particular theory, applicant believes that such O-rings cause a patch that is contiguous with it to effectively contact the entire interior diameter of gun bores. Even which such gun bores have irregular diameters, and/or rifling, the flexible nature of the O-rings allows them and the patch to contact the gun bores, compressing and/or expanding as is necessary.

FIG. 2 is a perspective view of the back of gun bore cleaner 10. Referring to FIGS. 1 and 2, it will be seen that a multiplicity of O-rings 14 are disposed in grooves (not shown in FIGS. 1 and 2) on the assembly 10.

The grooves are better shown in FIGS. 3 and 4. FIG. 3 is a side view of the assembly 10 illustrating grooves 15, 17, and 19 disposed in the body 12. In the embodiment depicted in FIG. 3, body 12 is comprised of head 18 that preferably comprises a first arcuate section 20 joined to a second arcuate section 22 by a flat section 24. In another embodiment, not shown in FIG. 3, the head 18 is comprised of a continuously arcuate section.

Without wishing to be bound to any particular theory, applicant believes that arcuate sections 20 and 22 minimize the possibility of damage to the gun bore and/or the cleaning patch during the cleaning operation.

Referring again to FIG. 3, it is preferred that the first groove, groove 15, is located at a distance 26 of least about 0.1 inches from the front 28 of the body 12, and it is preferred that it be located at least about 0.15 inches from such front 28. In one aspect of this embodiment, the first groove 15 is located at about 0.175 inches from such front 28.

Referring again to FIG. 3, it will be seen that second groove 17 is preferably located at distance 30 from the first groove 15 of at least about 0.07 inches and, more preferably, at least about 0.09 inches. In one aspect of this embodiment, distance 30 is at least about 0.11 inches.

Referring again to FIG. 3, it will be seen that the third groove 19 is preferably located at a distance 32 from the second groove 17 of at least about 0.07 inches and, more preferably, at least about 0.09 inches. In one aspect of this embodiment, distance 32 is at least about 0.11 inches.

Each of grooves 15, 17, and 19 is adapted to receive an O-ring 14 (not shown in FIG. 3).

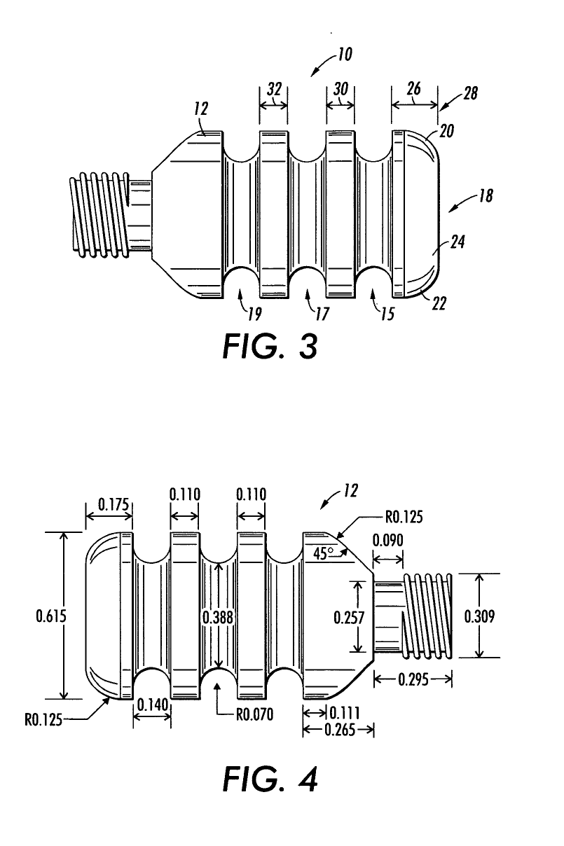

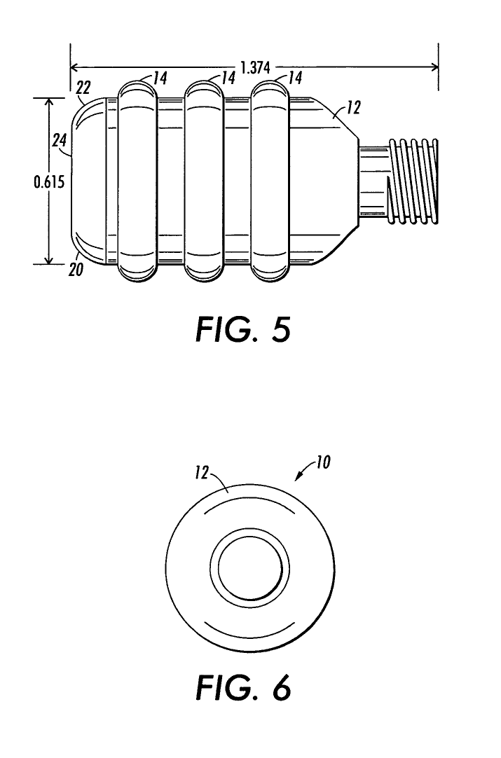

FIG. 4 is a manufacturer's view of one preferred embodiment of body 12. FIG. 5 is a manufacturer's view of the assembled part 10. FIG. 6 is an end view of the assembled part 10.

Referring again to FIGS. 1-6, an assembly 10 with three O-rings is disclosed. One can use fewer, or more such 0-rings. Thus, e.g., one may use from 1 to 10 such 0-rings. In another embodiment, from 1 to 3 such O-rings are used. In all such embodiments, the O-rings used have a top surface that extends beyond the top surface of the body 10. When the bore to be cleaned is larger than the sum of the thicknesses of the body 10 and the cleaning patch 60, the resilient O-rings insure that such cleaning patch 60 will nonetheless contact the interior surfaces of the bore.

One may use any of the O-rings known to those skilled in the art. Reference may be had, e.g., to U.S. Pat. Nos. 3,747,963 (flange assembly with O-ring gasket), 5,076,616 (hydraulic fitting with O-ring seal and stop), 5,328,557 (plasma treatment of O-rings), and the like; the entire disclosure of each of these U.S. patents is hereby incorporated by reference into this specification. Reference also may be had, e.g., to a publication by the Parker Hannifin Corporation, O-Ring Division, 2360 Palumbo Drive, Lexington, Ky., entitled “O-Ring Material Offering Guide (ORD 5712, Effective September, 2004). Referring to such publication, it is preferred that the O-ring have a Durometer hardness of at least about 50 and, preferably, at least about 60. In one embodiment, the Durometer hardness is at least about 70.

It is preferred that the material in the O-ring be chemically resistant to the solvents and cleaners commonly used in cleaning guns. In one preferred embodiment, the O-ring(s) comprise at least about 90 weight percent, or consist essentially of, nitrile rubber. As is known to those skilled in the art, nitrile rubber is the general term for acrylonitrile-butadiene terpolymer. In generaly, the acrylonitrile content of these nitrile rubbers ranges from about 18 to about 50 weight percent. Reference may be had, e.g., to U.S. Pat. Nos. 4,332,918 (nitrile rubber composition having high modulus), 5,569,719 (vulcanizable, partially hydrogenated nitrile rubber composition), 6,187,867 (hydrogenated nitrile rubber compositions containing thermoplastic polyolefins), 6,933,339 (nitrile rubber composition), and the like. The entire disclosure of each of these U.S. patents is hereby incorporated by reference into this specification.

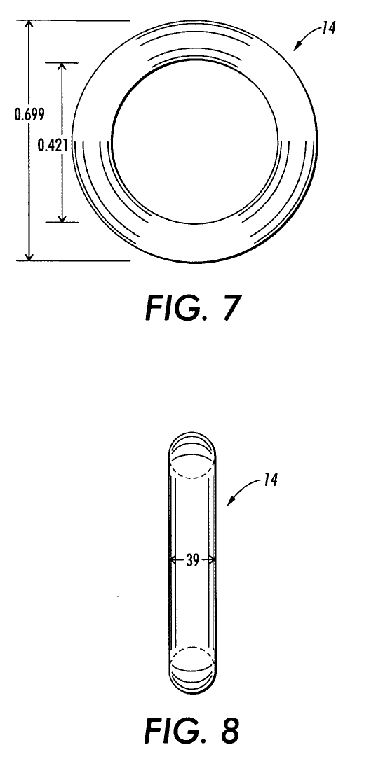

FIG. 7 is a side view of one preferred O-ring 14. FIG. 8 is a sectional view of such O-ring 14.

As is known to those skilled in the art, an O-ring is a flat ring made from synthetic rubber. Although O-rings are preferred, other rings may be used. These rings need not be flat, as long as the fill the grooves 15, 17, and 19. Furthermore, these rings need not be made from synthetic rubber as long as they preferably are resilient and chemically resistant to the cleanings materials commonly used for cleaning guns.

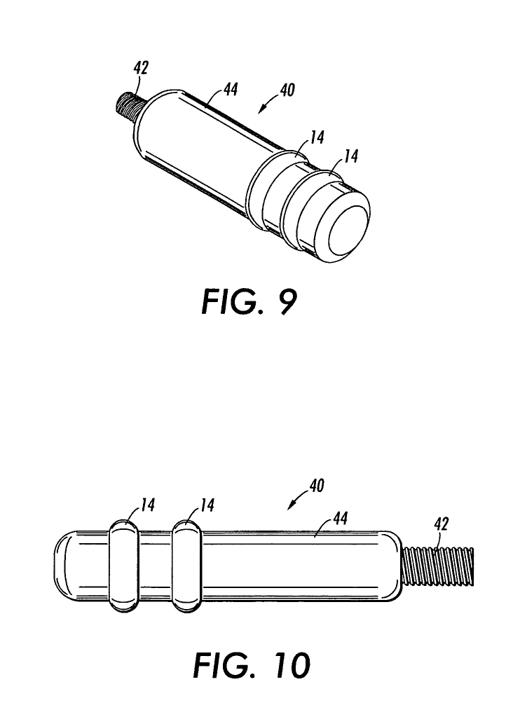

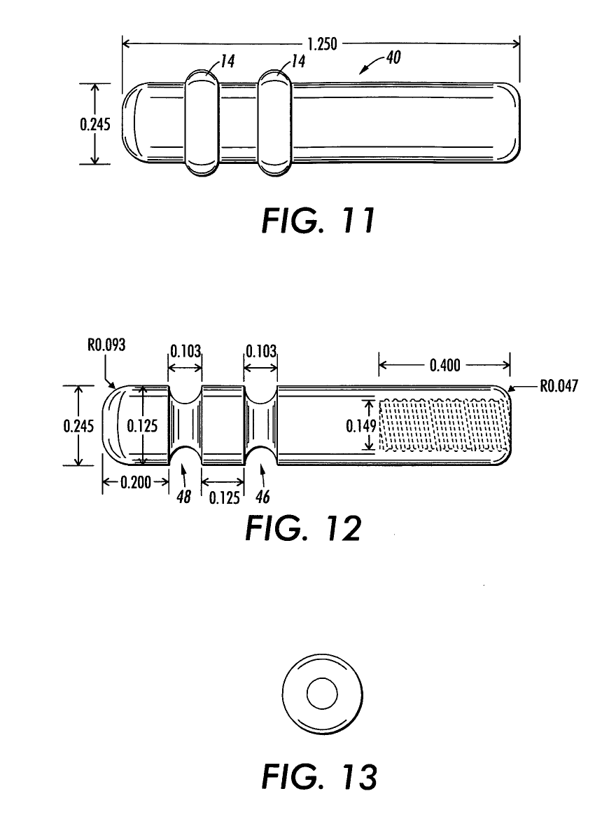

FIGS. 9 and 10 are perspective views of a a bore cleaning assembly 40 that is similar to assembly 10 but differs therefrom in that (a) it has only two O-rings 14 rather than three such O-rings, (b) it comprises a mounting stud 42 that is removably connected to the body 44 (whereas, in the embodiment of FIGS. 1 and 2, the mounting stud 13 is integrally connected to the body 12), and (c) the mounting stud 42 is preferably made from a steel (rather than from aluminum alloy), and (d) it has different dimensions, although it may also be made from other material(s) such as, e.g., the aluminum and/or the brass described elsewhere in this specification.

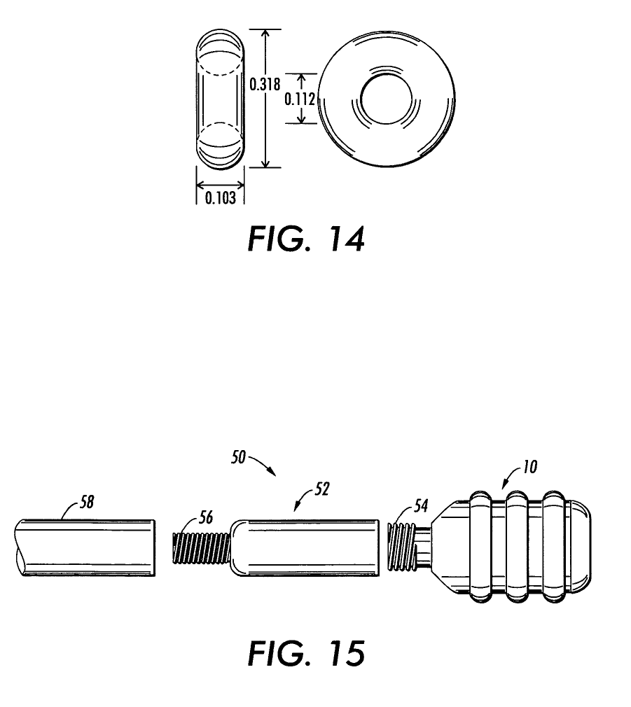

FIG. 12 is a manufacturer's view of one preferred embodiment of the body 40 without O-rings. FIG. 13 is an end view of the body 40. The grooves 46 and 48 are adapted to receive different O-rings than are used in the embodiment depicted in FIGS. 1 and 2. One preferred O-ring used with such grooves is depicted in FIG. 14.

In one embodiment, not shown, the O-rings used in the cleaning assembly have different cross-sectional dimensions. In this embodiment, the cross-sectional dimensions of the O-rings preferably differ from each by at least about 10 percent.

FIG. 15 illustrates an assembly 50 that is comprised of bore cleaner 10 (see, e.g., FIG. 1) that may be connected to adapter 52. The adaptor 52 preferably has a female thread (not shown) that is adapted to receive the male thread 54 on mounting stud 13. As will be apparent, the adaptor 52 may be made with female thread (not shown) that is adapted to receive the male thread on mounting stud 42 (see FIGS. 9 and 10).

The adaptor 52 also has a male thread 56 that is adapted to be received by the female threads of cleaning rod 58. The cleaning rods are well known. Reference may be had, e.g., to U.S. Pat. Nos. 3,609,790 (multicaliber and multigauge sectional gun cleaning rod), 5,075,998 (gun cleaning rod with swivel handle), 5,357,705 (gun cleaning rod), 5,558,242 (gun barrel cleaning rod), and the like. The entire disclosure of each of these U.S. patents is hereby incorporated by reference into this specification.

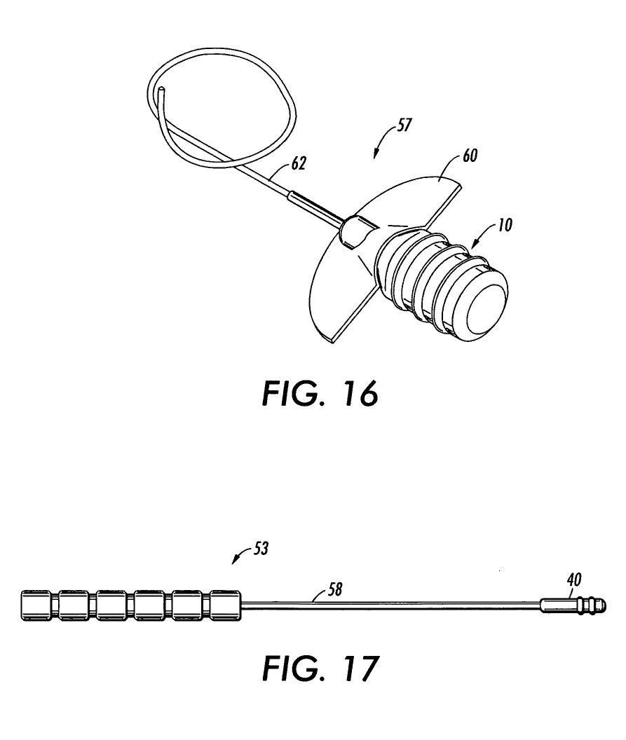

As is illustrated in FIG. 16, a cleaning patch 60 may be disposed between the adapter 52 and the mounting stud 54 and preferably held in place as one is screwed into another; alternatively, one may make a small hole on the cleaning patch and dispose it between the adapter 52 and the mounting stud 54.

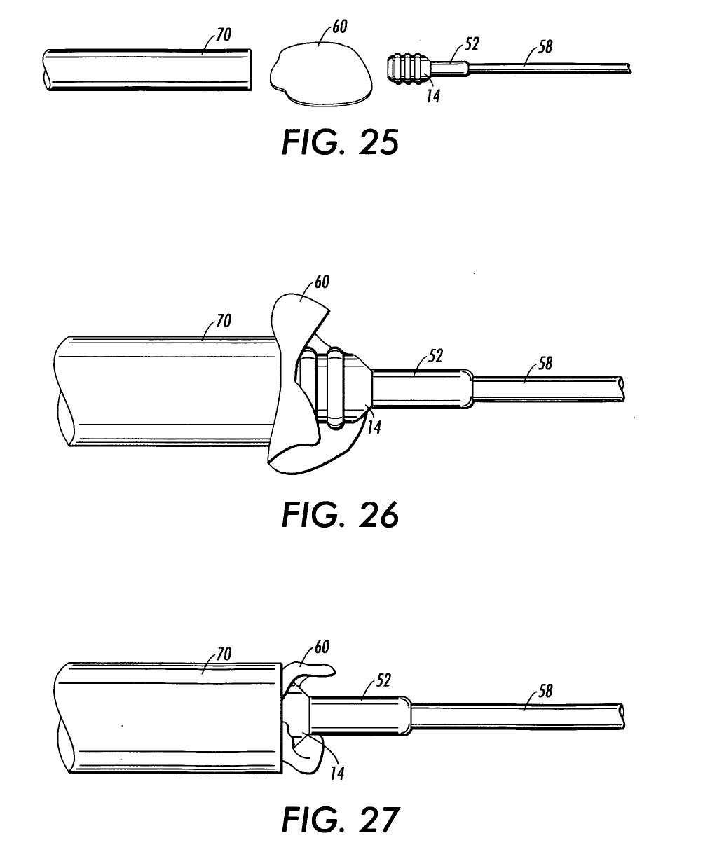

In the embodiment depicted in FIG. 25 et seq., by comparison, the cleaning patch 60 is disposed over the body 10.

Referring again to FIG. 16, and to the preferred embodiment depicted therein, a cable 62 is operatively connected to the adaptor 54; as will be apparent, this cable may be fished through the gun bore to clean it while the assembly 51 is being pulled through.

The assembly 53 depicted in FIG. 17 differs from the assembly 50 in that no adapter 52 is required. Inasmuch as the body 40 is comprised of a female thread, such female thread may be directly connected to the cleaning rod 58 (see FIG. 17) rather than the mounting stud 42 (see FIGS. 9 and 10).

In the FIGS. 15, 16, and 17, a cleaning rod 58 and/or a cable 62 is shown with a female thread, and such female thread is operatively connected to a male thread on the assembly 10 and/or the assembly 40. Some cleaning rods 58 and/or cables 62 are equipped with male threads; in such cases, the assembles 10 and 40 can be equipped with mating female threads.

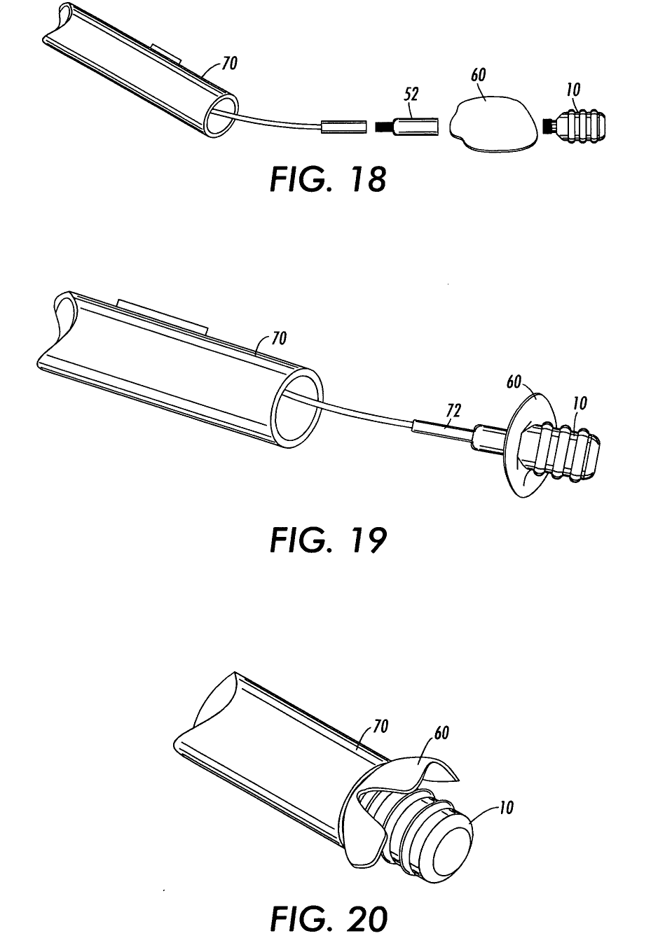

FIGS. 18, 19, and 20 depict the assembly 51 of FIG. 16 being pulled through a gun barrel 70.

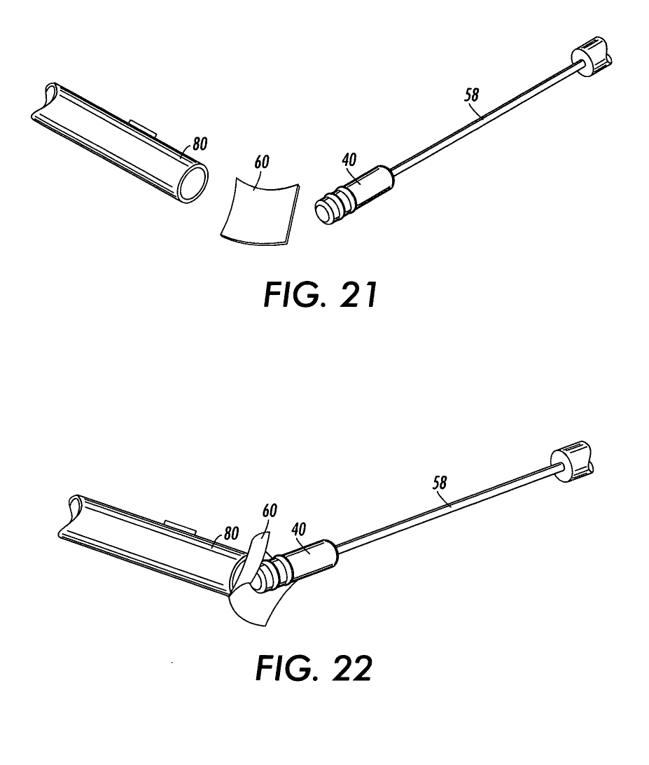

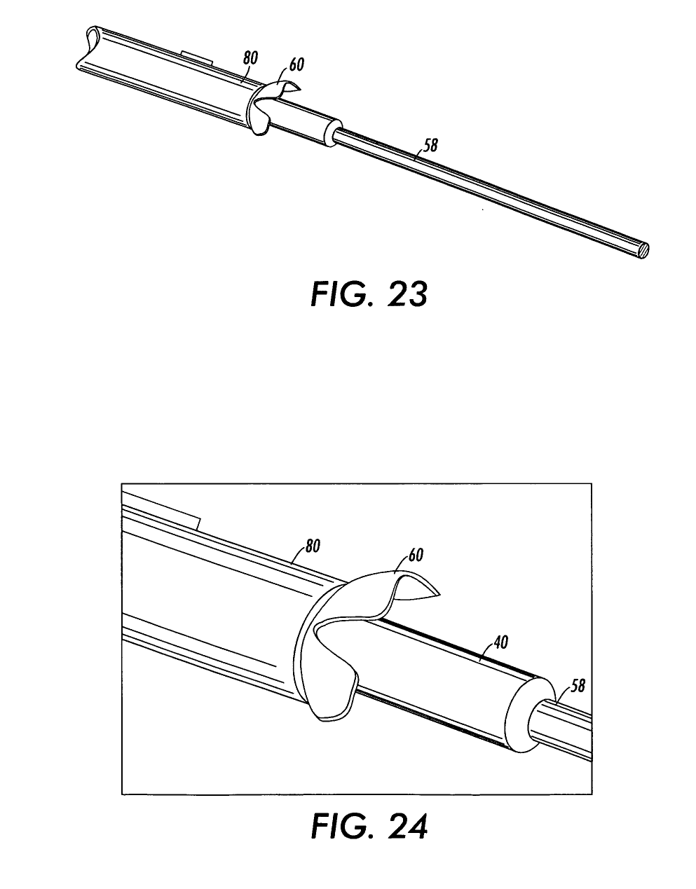

FIGS. 21, 22, 23, and 24 depict the assembly 53 (see FIG. 17) being pushed through a different gun barrel 80 with cleaning patch 60.

FIGS. 25, 26, and 27 depict the assembly 50 (see FIG. 15) being pushed through the gun barrel 70 with cleaning patch 60

One may use different cleaning materials instead of cleaning patch 60. Thus, e.g., one may use other fabric material, steel wool, felt, scouring pad material (such as “SCOTCH BRITE”), etc.

FIG. 28 depicts an assembly 90 comprised of an arcuate head 92, a first rubber disk 94, a spacer 96, a second rubber disk 98, an assembly body 100, and an attachment mounting study 102. FIG. 29 illustrates how such an assembly may be produced.

Referring to FIG. 9, a screw 93 with a round head 92 is connected to a first rubber disk 94, which is disposed over said screw. Thereafter, a spacer 96 is disposed over the screw, and a second rubber disk 98 is then disposed over the screw. The assembly so produced is then attached to a body 100 comprised of mating threads. The body may then be attached to a cleaning assembly (such as, e.g., a cleaning rod) by means of mounting stud 102. As will be apparent, this assembly can be utilized in substantially the same manner as the assemblies depicted in FIGS. 1, 2, 9, and 10.

Instead of the elastomeric O-rings, or the elastomeric rubber disks, one may use other materials and other assemblies such as, e.g. felt, plastic, Teflon, “SCOTCH BRITE,” cotton, and the like.

As will be apparent to those skilled in the art, because the material disposed within grooves 14 is resilient, when it is compressed by the surface of the bore being cleaned it will tend to regain its initial shape and, consequently, will cause the cleaning patch to push against the surface of the bore.

In one preferred embodiment, the assemblies depicted in FIGS. 1, 2, 9, and 10, and similar assemblies, comprise plastic material and, because of their relatively inexpensive costs, may be disposable.

The assemblies described hereinabove, although there are especially useful for cleaning gun bores and rifling, may also be used to clean other cavities such as, e.g., pipes and tubes.

The assemblies, in addition to being pushed or pulled through the orifices as described hereinabove, may be pushed or pulled through such orifices by hydraulic and/or pneumatic pressure.

As will apparent to those skilled in the art, the cleaning assembly of this invention, and the process that utilizes, may be adapted to any of the bores of the rifes, pistols, shotguns, and muzzle loaders that are commercially available. One may, e.g., modify the dimensions of body and/or the dimensions of one or more of the O-rings 14 and/or the thickness of the cleaning patch 60.

The cleaning patch 60 preferably contains cleaning solvent. The cleaning patch may, e.g., may be cut from 0.03 inch thick cotton flannel cleaning cloth. Alternatively, the cleaning patch may comprise or consist essentially of polyester or other synthetic fabrics. The cleaning patch preferably is comprised of a cleaning solvent that, e.g., may be water based, petroleum based, comprised of aromatic solvents, etc. In one embodiment, the cleaning assembly of this invention is comprised of a patch impregnated with a paste-based cleaning composition.

I claim:

1. An assembly for cleaning a bore, wherein said device is comprised of a body comprised of a first annular groove, an integral resilient material disposed in said first annular groove, a cleaning material disposed over said integral resilient material, and means for attaching said body to a cleaning material.

2. The assembly as recited in claim 1, wherein said cleaning material is a cleaning patch.

3. The assembly as recited in claim 2, wherein said integral resilient material is in the shape of an O-ring.

4. The assembly as recited in claim 3, wherein said assembly is comprised of from 1 to 3 of said annular grooves from 1 to 3 O-rings, each of which is disposed within one of such annular grooves, and wherein said cleaning patch is disposed over each of said O-rings.

5. The assembly as recited in claim 4, wherein each of said O-rings is comprised of an outer surface that extends beyond the outer surface of said body.

6. The assembly as recited in claim 4, wherein said cleaning patch is disposed over each of said O-rings.

7. The assembly as recited in claim 5, wherein said body is comprised of a head, wherein said head contains an arcuate section.

8. The assembly as recited in claim 1, wherein said means for attaching said body to a cleaning device is comprised of a mounting stud.

9. The assembly as recited in claim 8, wherein said mounting stud is removably connected to said body.

10. The assembly as recited in claim 9, wherein said cleaning patch is disposed between said mounting stud and said body.

11. The assembly as recited 8, wherein said mounting stud is connected to a cable.

12. The assembly as recited in claim 8, wherein said mounting study is connected to a cleaning rod.

13. The assembly as recited in claim 3, wherein said assembly is comprised of at least 2 of said O-rings, and wherein at least two said O-rings have different cross-sectional dimensions.

14. The assembly as recited in claim 1, wherein said body consists essentially of plastic material.

15. The assembly as recited in claim 7, wherein said head is defined by a continuously arcuate section.

16. The assembly as recited in claim 2, wherein said cleaning patch is impregnated with a cleaning solvent.

17. The assembly as recited in claim 2, wherein said cleaning patch is impregnated with a cleaning paste.

18. The assembly as recited in claim 2, wherein said cleaning patch is comprised of cotton.

19. A process for cleaning a bore, comprising the steps of disposing the cleaning assembly recited in claim 1 within said bore, compressing said integral resilient material, and moving said cleaning assembly through said bore.
